(19) United States
(12) Patent Application Publication
(10) Pub. No.: US 2010/0284187 A1
(43) Pub. Date: Nov. 11, 2010

(54) PLANAR ILLUMINATION DEVICE

(75) Inventors: Hans Layer, Ulm (DE); Bertrand Jannon, Horn (DE)

Correspondence Address: BANNER & WITCOFF, LTD., TEN SOUTH WACKER DRIVE, SUITE 3000, CHICAGO, IL, 60606, US

(73) Assignee: ALCAN TECHNOLOGY & MANAGEMENT LTD., Neuhausen am Rheinfall (CH)

(21) Appl. No.: 12/663,072

(22) PCT Filed: May 21, 2008
(86) PCT No.: PCT/EP2008/004070

§ 371 Date: Jul. 26, 2010

(30) Foreign Application Priority Data
Jun. 5, 2007 (EP) 07405161.6

(51) Int. Cl. F21S 4/00

(52) U.S. Cl. 362/249.01

(57) ABSTRACT

Planar illumination device comprise light-emitting illumination elements arranged on a carrier, containing an electrically conductive layer and an insulating 5 layer (LEDs). The light-emitting illumination elements are connected to current feed lines in the form of a conductor path. The light-emitting illumination elements are arranged as a succession of identical units on a continuous conductor path, in each case on the electrically insulating layer of the carrier. The current discharge from the light-emitting illumination elements is represented by a conductor discharging the current and by means of a connection to the electrically conductive layer of the carrier. The planar illumination device has any number of units extending in the longitudinal and transverse direction. Cutting zones, along which any units or groups of units can be separated off or separated out, are arranged between the units.

The present invention relates to a planar illumination device with light-emitting illumination elements which are arranged on a carrier, containing an electrically conductive layer and an insulating layer, and which for the current supply are connected to current feed lines in the form of at least one conductor path.

Planar illumination devices are known from WO 2006/097225. Light-emitting illumination elements are described therein, arranged on a carrier. A metallic foil is called a carrier. The carrier is covered with an insulating layer. Conductor paths are arranged on the insulating layer as current feed lines and current discharge lines and illumination elements and series resistor faces are arranged in between in series connections.

The object of the present invention is to expand the application area of planar illumination devices and to propose new illumination devices with further possibilities for use.

According to the invention, this is achieved in that the light-emitting illumination elements are a succession of identical units on a continuous carrier path, arranged on the electrically insulating layer of the carrier, and the electrically conductive layer of the carrier represents the current discharge.

Diodes, such as so-called LEDs (light emitting diodes) are present, for example, as light-emitting illumination elements.

Carriers are, for example, foils of multi-layer construction. A foil-like structure may contain, lying adjacent to one another, an electrically conductive layer and, on one side of the electrically conductive layer, an electrically insulating layer.

The electrically conductive layer may, for example, be a metal layer or a metallic layer. The metal layer may be a metal foil, such as, for example, a gold, silver, iron, steel, copper, tin or aluminium foil. The metal foils may also be made of alloys containing at least one of said metals. Aluminium foils, or foils made of aluminium alloys are preferred. It is also possible to use multi-layer foils made of at least two different metals. Typically thicknesses of said metal foils extend from about 3 μm to 300 μm, thicknesses of 7 μm to 70 μm being particularly suitable for aluminium foils. Owing to the selection of, for example, the thickness, the hardness, the elasticity etc., of the carrier materials, in particular the carrier foils, flexible, bendable, rollable or other two- or three-dimensionally deformable illumination devices may be provided, from case to case provided with a prestressing. Instead of the metal foils, foils or materials thicker than the given 300 μm may be used, such as, for example, bands, metal sheets or profiles. This may be necessary, for example, when the electrically conductive layer is simultaneously to have a tarrying function or dimensional stability is to be achieved. To dissipate the heat produced by the light-emitting illumination elements, the surface of the metal foils or sheets may be increased by folds or by the application of cooling ribs on profiles. A metal layer may also be produced by means of an electrically conductive metal-containing lacquer, which is applied to a substrate, such as a plastics material substrate or paper, etc.

The metallic layer may be a metallic layer produced in particular on a plastics material, for example in a foil form and deposited by a chemical or physical depositing method. The coating may take place by a chemical method, such as plastics material galvanisation or by the application or spraying on of solutions, such as cathode sputtering. Examples of physical deposition are sputtering or vapour deposition in a vacuum. If the metal layer is sputtered on or the metal layer deposited in a thin layer vacuum method, the deposited or vapour-deposited metals, for example gold, silver, copper, iron, nickel, tin, zinc, aluminium etc, may be alloys or mixtures thereof or the layers may contain these metals. Sputtered on or vapour-deposited layers may, for example, have a thickness of 2 to 200 nm (nanometres).

The insulating layer may be a paper, a coated paper, cardboard tray, cardboard or paperboard or a plastics material. Coated papers may be papers coated with waxes, hot melt or plastics materials. Examples of the plastics materials which can be used are polyvinyl chloride, polyolefins, such as polyethylene or polypropylene, polycarbonates, polyamides, polyesters, polyacrylonitriles, polystyrenes or their copolymers or graft polymers etc. Rubber is also suitable as the insulating layer. The insulating layer made of plastics material is preferably present as a film. The films may also be laminates or layered materials of two or more plastics material layers and may have been produced, for example, by lamination or extrusion. Typical thicknesses of films of this type are 12 μm to 200 μm. The insulating layer may also be used in thicknesses above the 200 μm given, for example as a plate or moulded part, if the insulating layer is simultaneously to have a carrying function or dimensional stability is to be achieved.

The electrically insulating layer is preferably present as a plastics material film and the electrically conductive layer is preferably present as a metal foil. The two foils can be connected to one another by means of primers, by means of primers and adhesives, or by means of adhesives, by lamination. The plastics material may be extrusion-laminated as a layer onto the metal foil in a different manner. The parts supplying current of the light-emitting illumination elements are generally printed onto the electrically insulating layer, applied wet chemically or vapour-deposited or a whole-area conductor layer is removed on the insulating layer, such as evaporated or etched away, to such an extent that the required conductor paths and conductor path portions remain with the action of a series resistor.

Hard-rolled aluminium foils are particularly advantageously used as the carrier foil. The carrier foil is provided in a planar manner with an insulating layer, for example with an outer varnish layer as the insulating layer. The various conductor paths and connection contact faces can be printed onto the outer varnish layer, for example by the gravure printing method, in one or more layers with an electrically conductive paint, for example a silver conductive paint. From case to case, the series conductors can be printed on with a further conductive paint, such as a silver and/or graphite, preferably a graphite conductive paint. In this case, in one gravure printing operation, the conductor paths being used for current supply and current distribution in the face of the illumination device and also the connection faces for the light-emitting construction elements are printed on in the silver conductive paint. Advantageously, the resistor faces of the series resistors consisting, for example, of graphite conductive paint, which are fed by input and output lines preferably consisting of silver, are printed on by the gravure printing method. The required power loss of the series resistors is achieved by the relatively large-area configuration of the printed-on resistor faces. The light-emitting illumination elements are glued, for example, with a silver-containing conductive glue to the corresponding connection contact faces or soldered thereto. Silver-containing conductive adhesives have a very small coefficient of heat conduction, so good heat dissipation from the light-emitting illumination elements to the metal carrier foil takes place.

The individual illumination elements, for rn example light-emitting diodes, can dissipate the heat produced during operation into the carrier, for example the metallic carrier foils being used as carriers. The individual illumination elements may have a power consumption of, for example, 0.1 watts to 5 watts. Not only weak LEDs with, for example, 0.1 to 0.5 watts, but also so-called power LEDs with, for example, 2 to 5 watts, preferably 3 watts, may be used. Depending on their number, the LEDs may be operated at an operating voltage of, for example, 20 V. Thus, the operating voltage lies in the region of small voltages according to the VDE standards. The outlay for insulation is therefore advantageously kept low. The LEDs may also be semiconductor chips without a housing, which are directly glued on and bonded with wire, or connected.

The light-emitting illumination elements are a succession of units, preferably a succession of identical units, which extend in the area in one or both directions. The light-emitting illumination elements can be produced, for example, continuously in the form of a carrier path, the width and length of the carrier path being uncritical per se and dependent on the starting materials and the mechanical situation. Light-emitting illumination elements are typically arranged in a path-shape with, for example, 1 to 100 units over the width of the carrier path and 1 to any number of units, which extend over the length of the carrier path.

Planar illumination devices, the continuing carrier path of which is at least one unit wide and at least two units long, are expedient. 2 to 50 units are preferred in a carrier path width. 2 to 200 units are preferred in a carrier path length.

In a particularly favourable embodiment, the units of the planar illumination device are in each case aligned or in a repeat pattern in the longitudinal direction and/or in the transverse direction. The units may also have individual outer limitations. A later division of a planar illumination unit into selectively arranged groupings of units is correspondingly more laborious.

Each unit is advantageously surrounded by an endless conductor path in the planar illumination device. The surrounding conductor path is a part of the current supply, or current feed, within the planar illumination device. A current-conducting path leads from the surrounding conductor path to the LED. This current-conducting path, in its entire or in a partial length, is a resistor and thus forms the series resistor. The size of the resistor of the current-conducting path is achieved by the cross-sectional area and/or the conductivity of the path or a portion of the path.

Each unit may be connected to the adjacent unit(s) in a current-conducting manner by means of conductor paths.

Each unit of the light-emitting illumination element may be electrically conductively connected to the carrier through a recess in the insulating layer on the planar illumination device according to the invention. The carrier represents the current discharge. The recess through the insulating layer may be implemented, for example, by piercing by means of a needle-shaped instrument, by mechanical removal, such as punching or drilling, by etching or evaporation by means of an electron beam or laser beam. The current-discharging conductor of the light-emitting illumination element to the carrier foil may also be a conductor path, as described above. From case to case, it may prove to be necessary to improve the contact between the conductor path and the carrier foil, through the recess in the insulating layer, or even to set it up at all. This may take place by connecting the conductor path and the carrier foil by means of a conductive lacquer or by means of a solder point, which substantially pass through the recess.

The units are advantageously in alignment in each case in the longitudinal direction and/or in the transverse direction. Cutting zones are advantageously arranged between the units. The cutting zones are arranged between the individual units and thus form space for the cutting lines for the later isolating of the units or groups of units. As each unit is advantageously interconnected with the adjacent unit(s), in a current-conducting manner by means of conductor paths, any units can be cut off and function independently of one another.

An illumination device made of a large number of units may be provided. The illumination device may, for example, be a roll produced, in particular, mechanically and continuously or a sheet made of a sheet stack with a plurality of units. Cutting zones are advantageously arranged between the units. A separating cut may be placed between each unit inside the cutting zone and at least one unit may be removed from the illumination device or separated at the edge from the illumination device. The separation or removal of units or groups of units, or groups of units in a patterned arrangement, may take place by separating methods, such as punching or by means of blades or scissors. Separating methods, such as laser cutting methods, separation by means of a water jet and the like can also be used. Said separating methods may also be computer-assisted. This allows complex patterns to be separated or removed from the planar illumination device with the separating device or non-linear or curved cutting lines to be followed. Accordingly, the planar illumination devices may be divided into separate cutouts or portions of one or more units and be isolated. The portions or cutouts of one or more units may be loaded individually with current as desired and used and operated as illumination bodies.

To operate the planar illumination device according to the invention, at least one conductor path, for example one or more of the endless conductor paths or one or more of the conductor paths connecting the units, may be connected to the current by means of a current feed line. The electrically conductive layer is also connected to the current circuit by means of a current discharge line. Each diode or LED is now supplied by way of the endless conductor paths and the current-conducting path or series resistor with current and the current circuit is closed by means of the current discharge line to the electrically conductive layer.

In a further preferred configuration of the invention, the flexible metallic carrier foil is reinforced by a stable composite part, so self-supporting light panels can be produced. In this case, the carrier is fixed, for example on plates made of a compact, foamed or honeycomb-like material, such as a plastics material panel, a wood panel, a plastics material foam or a honeycomb plate, by adhesion, i.e. processed to form a composite part. The side with the light-emitting illumination elements may, for example, be covered by a plastics material protective layer which is optically transparent, changes the colouring of the light, or opaque, bringing about a diffused light distribution. Owing to the plastics material layer, the light-emitting illumination elements, conductor paths and resistors are also advantageously protected against mechanical and electrical influences. It is also possible to arrange, on one side of the planar illumination device, the stable composite part, and to arrange the plastics material protective layer on the side of the light-emitting illumination elements. A stable, dividable sandwich element with a heat-dissipating and/or a dimensionally stable rear and light-emitting front is produced. For the current supply of the LEDs, for example, a contact clip may be connected for current supply at at least one point on one of the conductor paths and, on the other hand, the current discharge may take place by way of a contact clip, which contacts the electrically conductive layer. Instead of one or more clips, the current conducting devices may also be soldered to the conductor paths or electrically conductive layer or otherwise fixed in a current-conducting manner.

The figures show, by way of example, embodiments of the present invention.

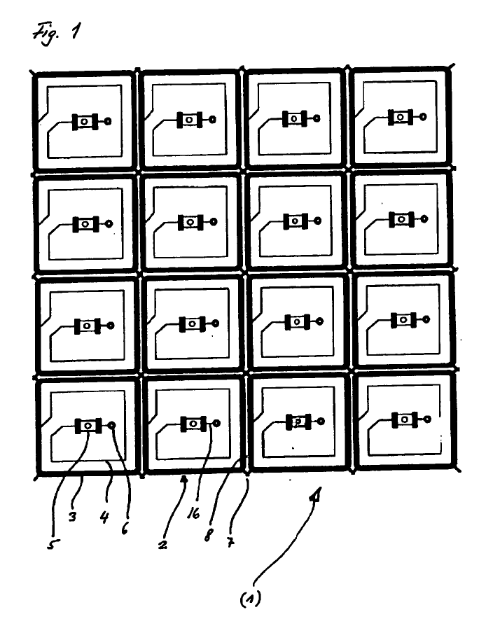

FIG. 1 shows a plan view of a planar illumination device.

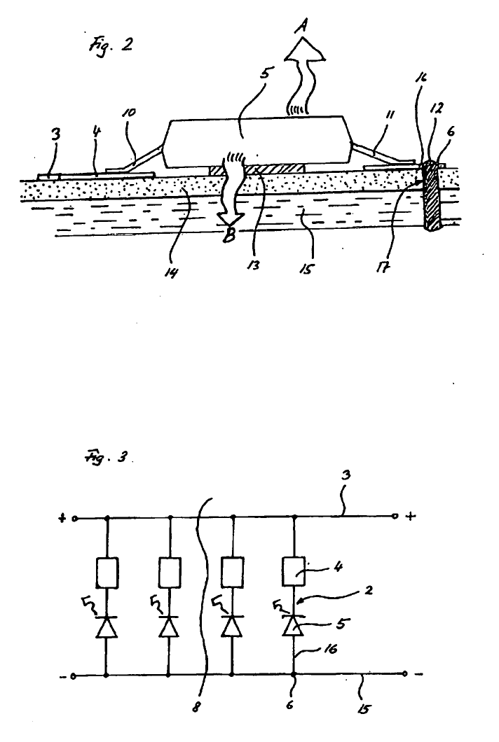

FIG. 2 shows a section through a part of a unit.

FIG. 3 shows an equivalent circuit diagram of the present illumination device.

FIG. 1 shows a plan view of a cutout 1 of the planar illumination device. The units 2 are arranged in the longitudinal and transverse direction. By way of example, 4 units 2 are shown in the longitudinal and in the transverse direction. The number of units 2 located next to one another or behind one another is not critical and depends on the width and the length of the carrier path and the mechanical situation, i.e. the units are applied endlessly in a repeat pattern on the carrier. The carrier in its structure contains an insulating layer and an electrically conductive layer. By way of example, the units 2 are shown substantially square. It is also possible for the units 2 to be shown as polygonal, such as rectangular, triangular etc, round, oval, etc. Each unit 2 is surrounded by an endless conductor path 3. A current-conducting path 4 branches off from the conductor path 3 in each unit 2. The current-conducting path 4 is the resistor over its whole length or over a part of its length. The current-conducting path 4 representing the series resistor or a part section thereof representing the series resistor may, for example, be made of silver or graphite or mixtures thereof or contain silver and/or graphite. These are, for example, lacquers, printing lacquers or paths which have been vapour-deposited or wet chemically deposited. The current-conducting path 4 is connected to the light-emitting diode (LED) 5. The current-conducting paths 4 are arranged on the insulating layer. A conductor leads onward from the diode 5, the conductor leading to a recess 6 in the insulating layer where it passes through the insulating layer and is connected to the electrically conductive layer. The units are mutually connected by supply conductors 7. The supply conductors lie between the corners of the conductor path 3. Instead of the crossing supply conductors 7, a sheet-like, such as a patch-like supply conductor, may also be provided between the respective 4 corners, or 2 corners at the edge of the carrier path, which supply conductor connects all four, or two, corners to one another in a conductive manner. The cutting lines 8 can be seen between the side edges of the adjacent units 2. Along the cutting lines 8, a planar illumination device according to the present invention can be cut as desired. It is possible to separate as many units as desired with respect to length and width from the band with the planar illumination device 1. It is also possible to cut out any patterns of units out of the full area or to separate out individual units or a plurality of units. The planar illumination devices which have been cut then only have to be connected to the current supply. A failure of a light diode or a current interruption in a conductor path only leads to the failure of the respective light-emitting diode affected. The current flow to and between the other units is ensured by the remaining conductor paths and the light-emitting diodes of the unaffected units accordingly remain activated.

FIG. 2 shows a section through a part of a unit 2. A light-emitting diode (LED) 5 is shown schematically, representing the housing. The diode 5 is connected mechanically and in a heat-conducting manner by means of a connecting compound 13 to the carrying structure, or the carrier, presently shown made of an insulating layer 14 and electrically conductive layer 15. The connection legs 10, 11 project from the diode 5. The current-supplying connection leg 10 is connected to the current-conducting path 4. At least a part-section of the current-conducting path 4 acts as a series resistor. The current-conducting path 4 opens into the conductor path 3. The current-discharging connection leg 11 is connected to the current-discharging conductor 16. The current-discharging conductor 16 leads to a recess 6. The recess 6 in the conductor 16 continues as a recess 17 through the insulating layer 14, completely passing through the insulating layer 14 and the electrically conductive layer. A conductive compound 12, such as, for example, an electrically conductive lacquer or solder produces the electrical contact between the electrically conductive layer 15 and the current-discharging conductor 16. Arrow A indicates the light emission of the diode 5. Arrow B shows the discharge of the heat produced in the diode 5 into the carrier.

FIG. 3 shows an equivalent circuit diagram of an illumination device according to the invention. A current-conducting path branches from the conductor path 3 to each of the four identical units 2. The current-conducting path leads to a series resistor 4, leaves the series resistor 4 and is connected to the light-emitting diode (LED) 5. The light emission is symbolised by an arrow. The current-discharging conductor 16 ends on a contact to the conductive layer 15. The contact may, for example, be a recess 6 in the insulating layer, not shown here. The contact between the current-discharging conductor 16 and the conductive layer 15 may be provided by a contact compound, such as a conductive lacquer or a solder extending through the recess. The cutting line 8 indicates that the units 2 can be separated from one another at that point, or as desired between two units 2.

1. Planar illumination device comprising light-emitting illumination elements arranged on a carrier, containing an electrically insulating layer and an 5 electrically conductive layer connected to current feed lines in the form of at least one conductor path, wherein the light-emitting illumination elements comprise a succession of identical units on a continuous carrier path, arranged on the electrically insulating layer of the carrier, and the electrically conductive layer of the carrier represents the current discharge.

2. Planar illumination device according to claim 1, wherein the continuous carrier path is at least one unit wide and at least two units long.

3. Planar illumination device according to claim 1, wherein the units are in each case in alignment in the longitudinal direction and/or in the transverse direction.

4. Planar illumination device according to claim 1, wherein each unit is surrounded by an endless conductor path.

5. Planar illumination device according to claim 1, wherein each unit is connected to the adjacent unit(s) by means of conductor paths in a current conducting manner.

6. Planar illumination device according to claim 1, wherein in each unit, the light-emitting illumination elements are connected in an electrically conductive manner to the electrically conductive layer of the carrier through a recess in the electrically insulating layer.

7. Planar illumination device according to claim 1, wherein cutting zones are arranged between the units.

8. Planar illumination device according to claim 1, wherein the units are in alignment in each case in the longitudinal direction and/or in the transverse direction, and cutting zones are arranged between the units.

9. Planar illumination device according to claim 1, wherein the illumination device is divided into separate cutouts, or portions of one or more units and isolated.
